(19) United States
(12) Patent Application Publication
(10) Pub. No.: US 2004/0036594 A1
(43) Pub. Date: Feb. 26, 2004

(54) Light bar control system

(76) Inventors: Robert Ladow, LaGrange, GA (US); Jim Buennagel, Fishers, IN (US); Mike Lamping, Indianapolis, IN (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/225,563

(22) Filed: Aug. 21, 2002

(51) Int. Cl. B60Q 1/26

(52) U.S. Cl. 340/468

(57) ABSTRACT

The present invention provides a light bar control system including a light bar controller connected to a control console interface through a power-line carrier communication network in a vehicle.

### BACKGROUND

Police emergency vehicles and many commercial application vehicles are generally not ready for service when delivered from a manufacturer. Such vehicles usually lack the equipment that is required by individual jurisdictions such as voice and data communications equipment, first aid materials, prisoner confinement hardware and emergency lighting, or light bars.

A light bar includes a collection of lights housed in an enclosure and often mounted on the roof of an vehicle. Emergency vehicles, such as a police cars, ambulances, fire trucks, and the like, typically use red lighting configurations. Non-emergency special application vehicles, such as tow trucks and recovery vehicles, typically use amber lighting configurations.

Accordingly, there are various light bar configurations that contain a number of lights (incandescent or LED) arranged in multiple circuits. The number of light circuits range from 1 to over a dozen, but typically, from 6 to 8. Each circuit provides different warning indications. The colors of the lights are combinations of red, amber, blue and white. Various light circuits provide strobe, flashing, rotating and continuous display. Flashing light circuits may be paired to provide an alternating flash or strobe pattern.

Currently, an outfitter must install individual light bars and control systems in vehicles as part of a time consuming and costly effort. After the light bar is attached to the roof of a police vehicle or commercial truck it must be connected to the driver's control console. The driver's control console is located inside the passenger compartment, either in, on or under the dash. The console may also be located in a console cluster between the driver and front passenger seats.

The connection between the console and light bar typically consists of a bundle of heavy gauge wires running from the light bar, through a hole in the roof, down the roof support column and then to the control console. The number of wires in the bundle is determined by the number of light circuits to be controlled and a power source supply. The number can range depending on the application. A typical light bar requires 9-wires. The size of each individual wire is determined by the electrical load required to operate each light circuit. A typical installation uses the same size (gauge) wire on each light circuit and a larger size wire for the power source supply. The resulting bundle of wires typically has a diameter ranging from 1-inch to 2-inches.

The driver's control console contains the switches and/or control relays to turn the individual light circuits on and off. These switches and relays must be of sufficient size to handle the light circuit loading and the console itself must provide the means to connect the wires in bundle. This generally requires the console to be large and consumes a required amount of scarce instrumentation space.

The present invention simplifies the installation and control of light bars through the use of power-line-carrier technology to replace all but one or two of the wires required to operate a light bar. Power-line carrier (PLC) is a communication method for transferring data between a location and a number of other locations by modulating an RF signal with the data and superimposing that RF signal on any existing wire, such as an electrical wire.

### SUMMARY OF THE INVENTION

The present invention includes one or more microprocessors connected to a vehicle network to provide bi-directional power-line carrier (PLC) communication between the driver's control console and a light bar.

An object of the present invention is to reduce the number of wires required to be connected to the light bar to no more than a power supply and chassis ground wire. Further, in an embodiment of the invention, where the light bar includes a suitable chassis ground, only a power supply wire is necessary. Accordingly, a single wire (sized to carry the power requirement of the light bar) eliminates the bundle of wires required in standard light bar installations.

It is a further object of the present invention to provide a power supply wire that does not need to be directly connected to the driver's control console for a light bar. Instead, the power wire may be connected to the vehicle's wiring network.

A further object of the present invention is to provide a driver's control console interface that connects to a variety of light control modules, providing adaptation of the console for various uses.

### BRIEF DESCRIPTION OF THE DRAWINGS

FIG. 1 is a relational block diagram depicting an embodiment of the present invention.

### DETAILED DESCRIPTION OF THE INVENTION

The present invention improves prior art light bar control systems through the use of power-line carrier (PLC) communications. By combining bi-directional data transfer and power supply on a common wire, the present invention eliminates multiple wire bundles required to directly connect present vehicle control consoles and light bars. Further, the present invention enables utilization of the vehicle's existing wiring to control light bar operation over a “vehicle network.”

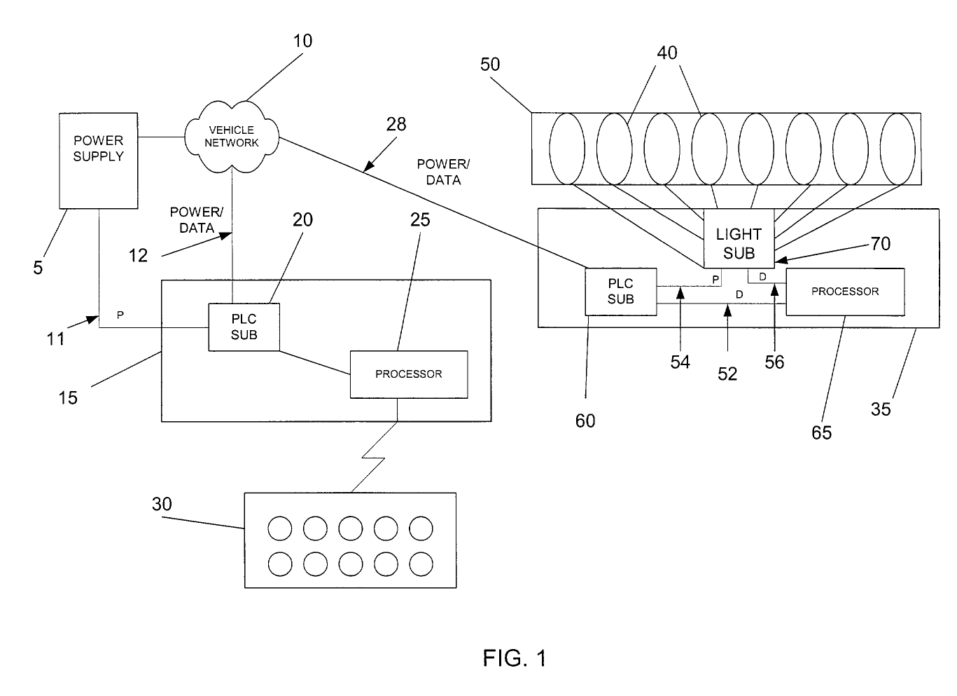

Referring to FIG. 1, the present invention includes a driver's control console interface 15 and a light bar controller 35.

The driver's control interface 15 includes a microprocessor 25 (with its support circuitry including power supervisor control and input/output interface) connected to a PLC subsystem 20. The PLC subsystem transmits and receives data using power-line carrier communications over the vehicle network 10, such as the electrical wiring of the vehicle in the present embodiment. The PLC subsystem 20 exchanges data with microprocessor 25 so that the processor 25 may use the data as desired at the console interface 15.

The driver's control console interface 15 connects to a light control module 30. The light control module 30 includes buttons and switches for operating light bar lights 40. The buttons and switches of the light control module 30 provide commands to the processor 25 which the processor 25 provides to PLC subsystem 20.

The light control module 30 may also include a display for rendering information regarding data transmitted from the processor 25 to such display of the light control module 30.

In an embodiment of the invention, the driver's control console interface 15 is adaptable for connection to a variety of light control modules 30, that include the switches and buttons for each particular light control application. Accordingly, the present invention provides modularity and interchangeability to end users, whether police jurisdictions, recovery services, and the like, to choose from a variety of control modules 30. Further, the size, shape, number of controls, style and location of a control module 30 (buttons and/or switches) can be customized to the needs of the end user.

The control console interface 15 and light control module 30 receive power via power line 11 connecting a power supply 5 to PLC subsystem 20. The power supply 5 may include a typical 12-volt vehicular battery, as well as typical inner-connection points to a vehicle battery within a vehicle.

The PLC subsystem 20 of control console interface 15 preferably includes one or more PLC connections 12 to the vehicle network 10. The vehicle network includes the existing electrical wiring of a vehicle connected to power supply 5. Both power and data arc transmitted over such existing wiring in the vehicle network 10.

A light bar 50, preferably mounted to the exterior of a vehicle roof, is connected to light bar controller 35. The light bar controller 35 is a low profile circuit board housed in an enclosure with mounting flanges and is encapsulated to protect it from the outdoor environment. The light bar controller 35 controls the light circuits connected to lights 40 of the light bar 50.

Any number of circuits may be supported by the present invention. One embodiment of the present invention includes an eight (8) circuit light system. In this embodiment, each circuit is preferably capable of drawing 40 amps of electrical power.

Further, a number of light bar power controllers and multiple driver's control console interfaces can be utilized to provide multiple access to each light bar power controllers. In this manner it is possible to adapt the present invention to be a general purpose vehicle power control system whenever there is a need for power load control at one location on a vehicle from a location elsewhere on the vehicle.

In a further embodiment of the invention, controller 35 is connected to the vehicle network 10 through single wire pair 28 providing power and bi-directional data to PLC subsystem 60 in the controller 35.

In an exemplary embodiment, data commands for operating one or more lights 40 are provided from the control console interface 15 over the vehicle network 10 and over power line carrier connection 28 to the light bar controller 35. The power line carrier subsystem 60 separates the data signal from the power signal and provides power to light subsystem 70 over power line 54 and data to/from processor 65 over data line 52.

Processor 65 thus receives the data commands from the control console interface 15 to provide operation data over data line 56 to light subsystem 70.

The light subsystem 70 interprets the light command data from the processor 65 to selectively provide power to one or more lights 40 of the light bar 50, as controlled by the user at light control module 30.

In a further embodiment of the present invention, light bar processor 65 may also receive feedback data regarding the control status, fault indications, current operational state, diagnostics, and the like, of one or more lights 40 connected to light subsystem 70. Processor 65 provides the feedback data over data line 52 to PLC subsystem 60. PLC subsystem 60 transmits the feedback data over power line carrier connection 28 to the vehicle network 10 and to the control console interface 15 over power line carrier connection 12 connected to power line carrier subsystem 20. Processor 25 of the control console interface 15 receives and interprets the feedback data to provide information regarding the light bar 50 to a display or indicator, such as an LCD display or LED indicator light, to the light control module 30. Thus a user can also monitor status and other feedback information regarding the lights 40 and light controller 35 of the light bar 50.

It will be appreciated that the present invention reduces the size of the prior art light bar wiring bundles (9-wires to 1-wire), reduces the size of the hole required in the vehicle's roof (from between 1-inch to 2-inches to less than 12 inch), eliminates the need to directly connect the light bar to the driver's control console, and dramatically reduces the space and size requirements of the driver's control console through modularity and PLC use.

In alternative embodiments of the invention, PLC may be replaced by other data transfer methods. For example, wireless data transfer may be used to send data from the driver's control interface 15 to the light bar controller 35 to control the lights 40. In such embodiments, the PLC subsystems 20 and 60 are replaced by wireless subsystems for exchanging data between processors 25 and 65. Such wireless connections may be made with low power spread spectrum ISM band transceivers, Bluetooth, 802.11a, 802.11b, and the like. It will be appreciated that in wireless environments the vehicle network wiring 10 is not used for data transfer.

Accordingly, while the invention has been described with reference to the structures and methods disclosed, it is not confined to the details set forth, but is intended to cover such modifications or equivalents as may fall within the scope of the following claims.

What is claimed is:

1. A light bar control system comprising:
a. a control console interface;
b. a light bar controller; and
c. a power-line carrier connection between the control console and light bar controller for operating one or more light bar lights.

2. The system of claim 1, wherein the control console interface and light bar controller are indirectly connected through a vehicle network.

3. The system of claim 1, further comprising a light control module connected to the control console interface, wherein the light control module includes one or more user controls for selectively operating said one or more light bar lights.

4. The system of claim 3, wherein the light control module includes a display for rendering information regarding data received from the light bar controller to a user.

5. The system of claim 2, further comprising a light control module connected to the control console interface, wherein the light control module includes one or more user controls for selectively operating said one or more light bar lights.

6. The system of claim 5, wherein the light control module includes a display for rendering information regarding data received from the light bar controller to a user.

7. The system of claim 1, wherein the light bar lights are attached to an emergency vehicle.

8. The system of claim 1, wherein the light bar lights are attached to a non-emergency vehicle selected from the group consisting of a towing vehicle and recovery vehicle.

9. The system of claim 5, wherein the light bar lights are attached to an emergency vehicle.

10. The system of claim 5, wherein the light bar lights are attached to a non-emergency vehicle selected from the group consisting of a towing vehicle and recovery vehicle.

11. A light bar controller comprising:
a. a power-line carrier interface; and
b. one or more light circuits connected to the power-line carrier interface for operating one or more light bar lights.

12. The light bar controller of claim 11, further comprising a transmitter for providing data feedback for said one or more light circuits to the power-line carrier interface.

13. The light bar controller of claim 11 including eight light circuits.

14. A light bar control console interface comprising:
a. a power-line carrier interface; and
b. a processor connected to the power-line carrier interface for providing one or more light bar commands to a light bar.

15. The light bar control console of claim 13, wherein the light bar commands are initiated from a user interface connected to the light bar control console.

16. The light bar control console of claim 14, wherein said light bar includes up to eight light circuits.
